(19) United States
(12) Patent Application Publication
(10) Pub. No.: US 2015/0121743 A1
(43) Pub. Date: May 7, 2015

(54) Dynamic Flow Live Bait Holder

(71) Applicant: Edward Kent ATHEY, Oxford, FL (US)

(72) Inventor: Edward Kent ATHEY, Oxford, FL (US)

(21) Appl. No.: 13/719,356

(22) Filed: Dec. 19, 2012

(51) Int. Cl. A01K 97/05; A01K 99/00

(52) U.S. Cl. CPC A01K 97/05; A01K 99/00
USPC 43/55

(57) ABSTRACT

Disclosed is a live bait keeper having a cornerless interior and dynamic flow of ambient water through it for freshening the water and protecting bait against harm when the holder is in water. The holder has a hollow, disc-shaped keeper body having forward and aft ends and cornerless interior space. The keeper is buoyant. A top hatch accesses the interior where bait is held. In use, ports on the top-portion of the keeper vent air and water from the interior, and bottom-ports disposed toward the forward-end of the keeper allow water to enter the interior. A tether attachment is disposed on the bottom-portion at the forward end below the neutral buoyancy plane of the keeper body, and as a tether maintains the forward end into the wind and/or current, the keeper rocks fore and aft forcing water into the bottom-ports to provide dynamic water flow into the bait holder.

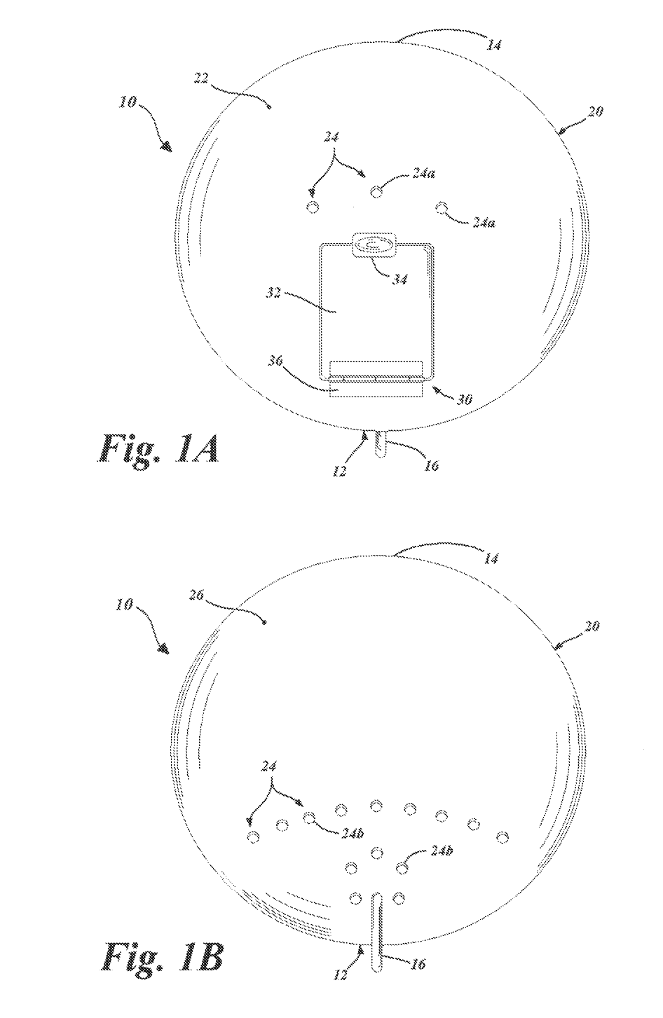

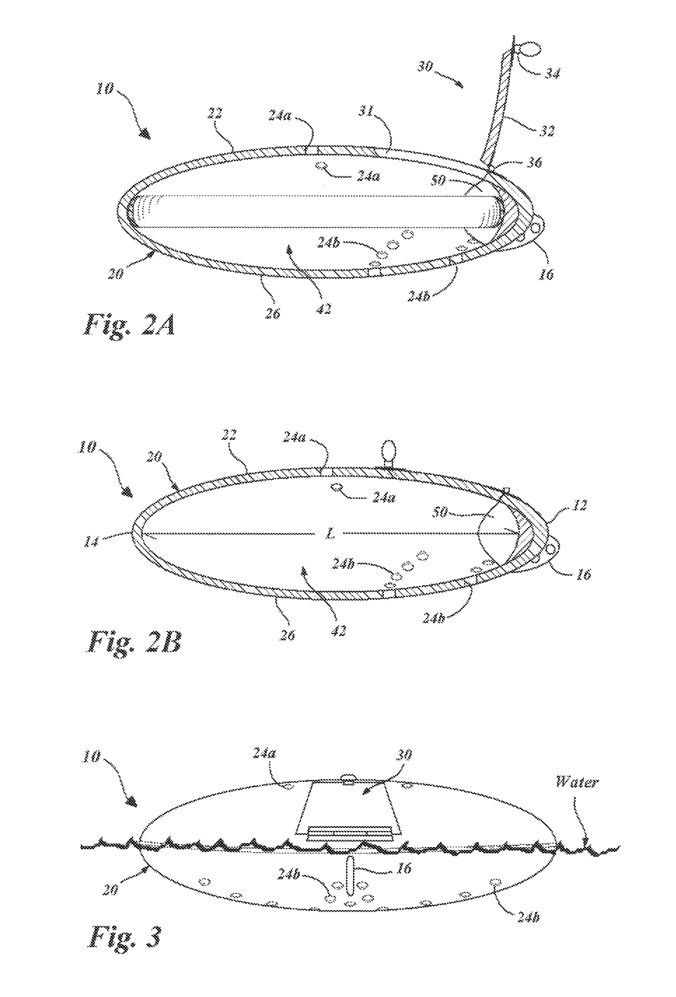

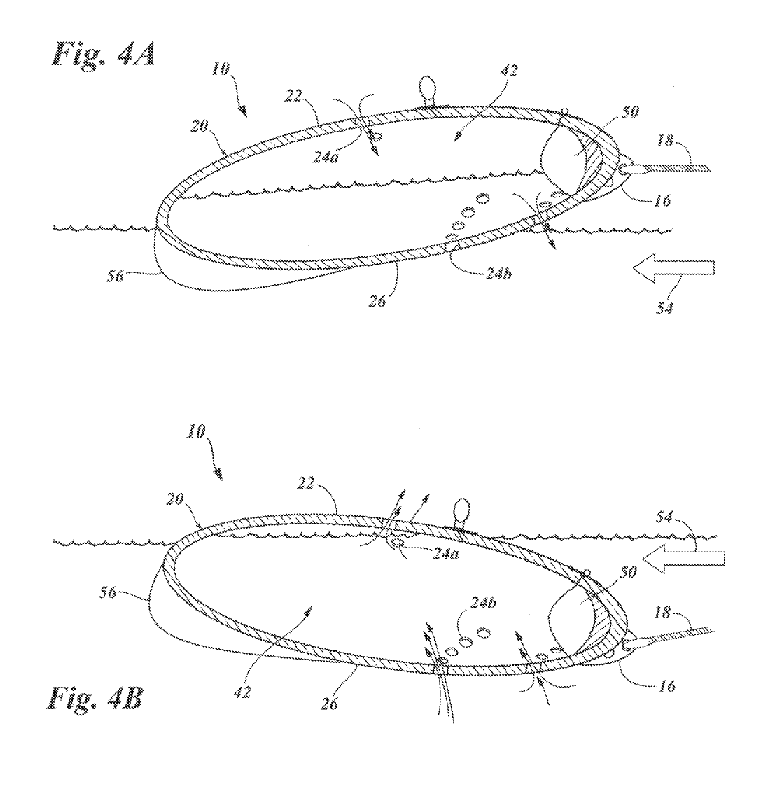

### FIELD OF THE INVENTION

The present invention is in the field of fishing (Class 43), and relates to holders (subclass 54.1) comprising a receptacle specifically designed for use in fishing for holding the bait. Specifically, the present invention relates to live bait holders (subclass 55) designed to keep such bait in a fresh condition. More specifically, the invention relates to live bait holders including some means for freshening the water, and for protecting the live bait against special harm when the holder is placed in water (subclass 56).

### SUMMARY OF THE INVENTION

The present invention is a dynamic flow live bait holder for in water use. The bail holder is “dynamic flow” in that it is adapted to utilize motion of the holder while in use to pump ambient water into the bait holder and internal water out, as a means for freshening the internal water. Additionally, the present live bait holder has an interior/receptacle space for holding the bait which has no internal corners. The corner-less interior space is a feature that provides for protecting the live bait against certain kinds of harm when the holder is placed in water.

The present dynamic flow live bait keeper comprises a keeper body, which is a hollow and buoyant disc-shaped housing for containing the bait. The body or housing is formed of two concave disc shaped members faced together. The disc shaped member form the top and bottom portions of the keeper body, and define the interior space. Substantially, the keeper body has no definable sides joined at an angle in the interior space. The largest cross-section of the interior space is substantially oblong and of sufficient dimensions to allow the bait fish to swim without bunching up (e.g., in corners). The corner-less feature of the interior space facilitates the object of the present invention of protecting the live bait against harm when the bait holder is placed in water by allowing the bait to be able to swim in a continuous course and to avoid bunching up against walls and corners in the receptacle space.

The present live bait holder has water & air vent-ports disposed on the keeper body. Top-ports are positioned on the top-portion of the keeper body to vent air and allow excess water to escape from the interior space, and bottom-ports are positioned on the bottom-portion of the keeper body primarily to allow water to enter the interior space of the keeper body. It is a feature of the present invention that there be bottom-ports, and that the bottom-ports are positioned toward the forward-end of the bottom-portion of the keeper body to allow water to enter the interior space. A hatch assembly is disposed on the top-portion of the keeper body and is operable to provide access to the interior space of the bait holder. A tether attachment is disposed on the forward end of the bottom-portion of the keeper body. When in use in the water (e.g., tethered to the angler or to a boat), the bait holder maintains its forward end into a wind and/or a current at a surface of the water.

Generally, the buoyancy of the present live bait holder is adjusted so that at neutral buoyancy, its draft when placed in water is proximate the plane of the keeper body's largest interior cross-section. Buoyancy can easily be adjusted by a user by the addition of weight to a desired place on/in the keeper body. It is also a feature of the present invention that the forward-end of the top portion of the keeper body curves downward. This feature serves to more forcefully drive the forward-end downward when the forward-end gets submerged in a current, to increase the pressure driving ambient water into the bottom-ports in the bottom-portion of the keeper body. Additionally, a porpoise weight can be disposed near the front end of the keeper body to promote movement of the forward-end of the keeper body with a rising and falling motion in response to the wind and current at the surface of the water. This motion helps to force water through the bottom-ports and into the interior space of the keeper body, to provide the dynamic flow of ambient water into the present live bait holder.

### DESCRIPTION OF THE INVENTION

Referring now to the drawings, the details of preferred embodiments of the present invention are graphically and schematically illustrated. Like elements in the drawings are represented by like numbers, and any similar elements are represented by like numbers with a different lower case letter suffix. The present invention is an in the water, dynamic flow live bait holder. The “dynamic flow” feature of the bait keeper derives from the structural elements of the bait keeper and their interaction when the bait keeper is placed in water, as will be explained below.

The dynamic flow bait holder has a keeper body which is a hollow and buoyant, and substantially disc-shaped container. The keeper body has a forward end, and an aft end as well as a top-portion and a bottom-portion. In one embodiment, the bottom-portion of the forward end has a tether attachment means. Additionally, the top-portion of the keeper body has a closeable hatch assembly, which allows access to a “corner-less” interior space of the body. The interior space of the keeper body is “corner-less” in that a perimeter around the largest dimension of the interior space is curved (and substantially circular) and there are no corner (i.e., sharp angles) in the interior space. This is an important structural feature of the present invention which helps live bait to be able to avoid bunching up (at a corner) and to keep swimming. The keeper body also has a number of vent ports on its top-portion and bottom-portion, which allow water flow between the interior space and the environment outside of the keeper body.

The keeper body has a hatch opening through its top-portion, which opening enables a user to access the interior space of the bait keeper. The hatch assembly is disposed on the top-portion of the keeper body to allow the hatch opening to be closed to prevent bait from escaping from the interior space of the keeper body. The hatch assembly includes a hatch door, a hinging means attaching the hatch assembly to the keeper body, and a latch for securing the hatch door closed. The interior space of the keeper body is “corner-less” in that a perimeter around the largest dimension of the interior space is curved (and substantially circular) and there are no corner spaces (sharp angles) in the interior space. This is an important structural feature of the present invention which helps live bait to be able to avoid bunching up (at a corner) and to keep swimming, which helps to keep the bait fresh longer. It is this feature that defines the substantially circular and oval shape of the bait keeper.

In use, the present dynamic flow live bait keeper is placed in the water where a person (such as a fisherman) intends to use it. The bait keeper is buoyant and floats in the water. Once the bait holder is placed in the water, it will fill with water to its neutral buoyancy level. Live bait is placed into the interior space of the keeper body through the hatch door and the hatch door closed. Similarly, bait may be removed from the bait holder as desired by the user. One end of a tether line is attached to the tether attachment of the keeper body. The other end of the line is attached to the fisherman his/herself, to a fishing boat or water craft, or to something stationary in the water. The force of the wind, or current in the water, or the motion the bait keeper over the water takes the bait keeper to the end of the tether line. Selection of an appropriate composition and length of tether line is readily accomplishable by a fisherman of ordinary skill in the art. Once the forces on the bait keeper take it to the end of the tether line, the forward end of the keeper body points into the force(s) acting on it. Optionally, a skeg may be added to the bottom-portion of the keeper body to facilitate keeping the forward end pointed into the force acting on the keeper body.

Once the bait keeper is taken to the end of the tether line, the force continues to act on it. Even very small forces, such as ripples and swells in the water, or movement of the fisherman or water craft, will cause the keeper body to rock back and forth (i.e., to porpoise forward end to aft end) in the water. The keeper body of the bait holder may be disposed to float level in still water, but preferable it floats in still water with a slight forward end down tilt. In a preferred embodiment, the forward end is heavier than the aft end to accomplish a nose or forward end down tilt to the bait holder. The nose down tilt disposition of the forward end can be accomplished by having the front end of the keeper body have a thickness that is greater than the thickness anywhere else on the keeper body. Alternatively or additionally, a porpoise weight can be added to the front end. The porpoise weight is a denser-than-water putty or resin applied to the inside wall of the interior space, proximate the forward end. Molding the porpoise weight into the wall of the front end and/or using a dense putty as the porpoise weight both have the advantage of maintaining the “corner-less” element of the interior space of the keeper body. Other weighting means are known to and selectable by one of ordinary skill in the art for practice in the present invention that do not compromise the “corner-less” element of the keeper body. For example, a fin or skeg (not shown) could be added to the front end of the keeper body to add weight to the front end and to help stabilize the keeper body in line with the direction of the force on it.

The degree of nose (forward end) down tilt can be adjusted by a user by adding or removing a buoyancy means to the bait holder. For example, a buoyancy means in the form of a closed-cell foam strip fixed to the inside wall of the interior space. Other weighting and buoyancy adjustment means are known to and selectable by one of ordinary skill in the art for practice in the present invention.

The “dynamic” limitation of the present live bait holder refers to the water pumping action of the keeper body as it rises and fall (porpoises) in the water. The point of attachment of the other end (not shown) of the tether line is disposed so that when the bait holder tugs at the end of the tether line, the front end of the keeper body tends to rise up out of the water. This can be accomplished by attaching the other end of the tether line to a point that is out of the water. The benefit of the dynamic limitation of the bait holder derives from the fact that in open water a floating object is almost never still. And as noted above, even very small forces, such as ripples and swells in the water, or small movement of the fisherman or boat will cause the keeper body to rock back and forth or to porpoise in the water.

As the bait holder rocks back and forth in the water, the front end of the keeper body rises out of the water. Due to the weight of the keeper body front end and because the kinetic energy of the water contained within the interior space is greater than the water outside the keeper body, the bait holder is no longer neutrally buoyant in the water. This is not withstanding that some of the interior water flows out of the bait holder through the bottom-portion ports. The increase in the kinetic energy of the front end of the keeper body due to its mass and the water it contains causes the front end to forcibly reenter the water. As the front end enters the water (it tends to pass through the neutral buoyancy level of the keeper body), the bottom-portion ports submerge below the surface of the water. Water then enters the interior space of the keeper body, replacing an amount of the water that had flowed out of the interior space when the front end of the of the keeper body was out of the water. The top-portion vent ports vent displaced air and excess water from the interior space and minimize potential water pressure build-up in the interior space regardless of the water pressure outside of the bait holder. As the front end returns toward neutral buoyancy, excess water in the interior space flows out through the bottom-portion ports.

In the above manner, as the present dynamic flow live bait holder rocks or porpoises back and forth in the water, some portion of the water contained in its interior space is removed and replaced with fresh water. Consequently, the water in the interior space is constantly refreshed. Additionally, the water pressure in the interior space is relative constant and substantially independent of the water outside of the bait holder even when the force is relatively high, as when the bait holder is being towed behind a boat. The constant pressure feature of the present live bait holder is an advantage that helps keep live bait fresh.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

What is claimed is:

1. A dynamic flow live bait holder (10) for in water use, the bait holder (10) comprising:
a keeper body (20), the keeper body (20) being a hollow disc-shaped container having a forward-end (12) and an aft-end (14), a top-portion (22) and a bottom-portion (26), and an interior space (42), and being buoyant at water's surface;
a hatch assembly (30) is disposed on the top-portion (22) of the keeper body (20) and is operable to provide access to the interior space (42) of the keeper body (20);
vent-ports 24 are disposed on the keeper body (20), with top-ports (24a) positioned on the top-portion (22) of the keeper body (20) to vent air and allow excess water to escape from the interior space (42), and with bottom-ports (24b) disposed toward the forward-end (12) of the bottom-portion (26) of the keeper body (20) to allow water to enter the interior space (42) of the keeper body (20); and
a tether attachment (16) is disposed on the bottom-portion (26) at the forward end (12) below to neutral buoyancy plane of the keeper body (20), and as a tethered maintains the forward end (12) of the keeper body (20) into a wind and/or a current at a surface of the water, the keeper body tends to rock fore and aft forcing water into the bottom-ports (24b) to provide a dynamic flow of ambient water into the live bait holder (10).

2. The dynamic flow live bait holder (10) of claim 1, wherein the live bait holder (10) has a draft when placed in water that is proximate the plane of the keeper body's largest interior cross-section.

3. The dynamic flow live bait holder (10) of claim 1, wherein the keeper body (20) of the live bait holder (10), when at neutral buoyancy has a slight forward-end down tilt.

4. The dynamic flow live bait holder (10) of claim 1, wherein the vent-ports (24) are positioned on the keeper body (20) away from the aft-end to avoid a venture effect caused by air and/or water passing over the ports from excessively sucking water from the interior space (42).

5. The dynamic flow live bait holder (10) of claim 1, further comprising:
a porpoise weight (50) disposed proximate the forward-end (12) of the keeper body (20) and is adapted to promote movement of the forward-end (12) of the keeper body (20) with a rising and falling motion in response to the wind and current at the surface of the water, to force water through the bottom-ports (24b) and into the interior space (42) of the keeper body (20), to provide the dynamic flow live bait holder (10).

6. A dynamic flow live bait holder (10) for in water use, the bait holder (10) comprising:
a keeper body (20), the keeper body (20) being a hollow and buoyant disc-shaped container having a forward end (12) and an aft end (14), a top-portion (22) and a bottom-portion (26), and an interior space (42);
a hatch assembly (30) is disposed on the top-portion (22) of the keeper body (20) and is operable to provide access to the interior space (42) of the keeper body (20);
vent-ports 24 are disposed on the keeper body (20), with top-ports (24a) positioned on the top-portion (22) of the keeper body (20) to vent air and allow excess water to escape from the interior space (42), and with bottom-ports (24b) positioned on the bottom-portion of the keeper body (20) to allow water to enter the interior space (42) of the keeper body (20);
a tether attachment (16) is disposed on the bottom-portion (26) of the forward end (12) of the keeper body (20) and when tethered maintains the forward end (12) of the keeper body (20) into a wind and a current at a surface of the water;
a porpoise weight (50) is disposed at the front end (12) of the keeper body (20) and is adapted to promote movement of the forward end (12) of the keeper body (20) with a rising and falling motion in response to the wind and current at the surface of the water, to force water through the bottom-ports (24b) and into the interior space (42) of the keeper body (20), to provide the dynamic flow live bait holder (10).
